(19) United States
(12) Patent Application Publication
(10) Pub. No.: US 2008/0263673 A1
(43) Pub. Date: Oct. 23, 2008

(54) System and method for delivering promotional and information content during a computer-based application and collecting impression metrics

(75) Inventors: Nicolas Brun, Brooklyn, NY (US); Nicholas Gonzalez, Winter Garden, FL (US); Jeffrey B. Katz, New York, NY (US); Patrick Vogt, Rancho Santa Fe, CA (US); Mirko Meier, Brooklyn, NY (US)

Correspondence Address: MICHAELSON & ASSOCIATES, P.O. BOX 8489, RED BANK, NJ, 07701-8489, US

(73) Assignee: Viewpoint Corporation

(21) Appl. No.: 11/906,111

(22) Filed: Sep. 28, 2007

Related U.S. Application Data
(60) Provisional application No. 60/848,123, filed on Sep. 29, 2006.

(51) Int. Cl. G06F 15/16; G06F 21/00; G06Q 30/00

(52) U.S. Cl. 726/26; 709/203; 705/14

(57) ABSTRACT

The present invention includes a system and method for displaying information content, such as advertisements, during a computer-based application, for example, an online video game or any Internet-enabled application, and for collecting user impression metrics associated with the information content, even if the application is not connected to the Internet or an associated application server. The system and method include a campaign management system for receiving information content to be displayed during a computer-based application, including a pack manager application for creating an information content pack containing the information content in content sets, a content delivery network to distribute the information content pack, and a client software development kit that downloads the information content pack to display the information content during the computer-based application, and collects and sends user impression metrics associated with the information content back to the campaign management system for reporting.

### CLAIM TO PRIORITY

This application claims the benefit of U.S. Provisional Patent Application Ser. No. 60/848,123, filed on Sep. 29, 2006, which is incorporated by reference herein.

### BACKGROUND OF THE DISCLOSURE

1. Field of the Invention

The present invention generally relate to a system and method for providing content while a computer-based application is running, and specifically, providing information and promotional content illustratively during a computer-based application, such as a computer game.

2. Description of the Prior Art

With the rise of Internet use and computer gaming, including console and online gaming, advertisers have been given new platforms to reach audiences beyond the traditional means of radio and television. In-game advertising allows companies to provide advertising to multiple marketing groups as gaming audience ages range from teenagers to adults three times that age. Further, advertisers are able to reach audiences on a global level easily through in-game advertising with a single ad. For example, a popular online game, WORLD OF WARCRAFT provided by Blizzard Entertainment, recently surpassed eight million users, with approximately two million of these users in the United States, 1.5 million of these users in Europe, and 3.5 million of these users in China. By displaying a single ad during game play, advertisers hit audiences around the world in an instant.

However, advertisers would be able to make even better use of their ads by being able to gather the audience reactions to the ads displayed during games. Thus, a need exists to provide advertisers with a means for collecting their audience's reactions to the ads displayed.

### SUMMARY OF THE INVENTION

A solution to the problem includes a system and method for displaying information content, such as advertisements, during a computer-based application, for example, an online video game, a mobile game, a console game, or any Internet-enabled application, and for collecting user impression metrics associated with the information content, even if the application is not connected to the Internet or an associated application server. The system and method include a campaign management system for receiving information content to be displayed during a computer-based application, including a pack manager application for creating an information content pack containing the information content in content sets, a content delivery network to distribute the information content pack, and a client software development kit that downloads the information content pack to display the information content during the computer-based application, and collects and sends user impression metrics associated with the information content back to the campaign management system for reporting.

### BRIEF DESCRIPTION OF THE DRAWINGS

So the manner in which the features of the present invention may be understood in more detail, a more particular description of the embodiments of the present invention, briefly summarized above, may be had by reference to embodiments, some of which are illustrated in the appended drawings. It is to be noted, however, the appended drawings illustrate only typical embodiments of the present invention and are therefore not to be considered limiting of its scope, for the present invention may admit to other equally effective embodiments, in which:

FIG. 1 presents a system configuration for providing information content during a computer-based application, in accordance with an embodiment of the present invention;

FIG. 2 is a flow diagram describing a method for providing information content during a computer-based application, in accordance with an embodiment of the present invention;

FIG. 3 provides an example of a content logic file, in accordance with an embodiment of the present invention.

### DETAILED DESCRIPTION

The present invention provides embodiments encompassing at least a system and a method for providing information content, such as advertisements, for display during user engagement of a computer-based application and for collecting user impressions associated with the information content even if the application is not connected to the Internet or to an online associated application server. The information content is displayed during the application in a variety of ways, including as a single text image displayed on a portion of an application screen or as a texture display within an application screen, where the texture display allows the information content to appear as a natural element within the application screen. The format of the information content displayed includes any type of text or multimedia content that can be displayed, played, or otherwise presented to the user in the game the ad is intended for. Such formats include, but are not limited to, text, sound files, graphical images, video images, three-dimensional objects, animations, textures, two-dimensional sprites, game objects, game levels, and game loading screens, and the like.

In one embodiment of the present invention, an example of a format for information content to be displayed during a computer-based application, such as an online video game, comprises a single image to be displayed by the game on a viewing screen, such as, during one or more of loading screens of the game. Loading screens can occur at any time during a game, such as, for example, during the initial startup of the game or once the game has ended. Such advertisements may encompass a portion of the screen, may cover the entire screen, or may be blended on top of the existing game loading screen to provide a more natural fit with the game.

In another embodiment of the present invention, an example of a format for an advertisement comprises a texture display, such as, for example, an in-game texture ad where an image is used as a texture for one or more objects displayed within the game world. Such objects include billboards, clothing, cars, furniture, walls, floors, or any other object in the game that is textured.

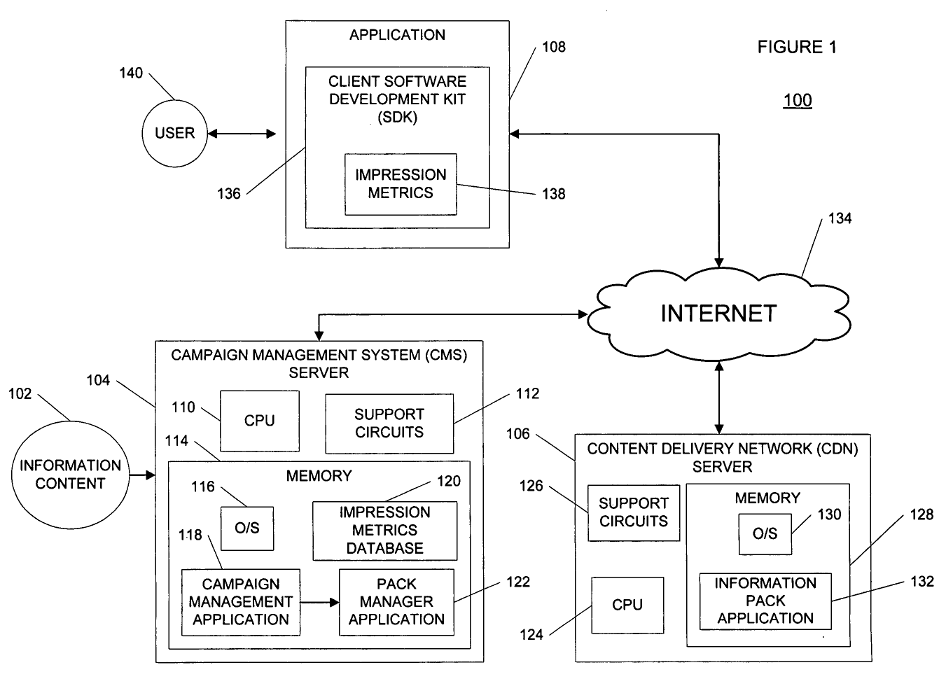

FIG. 1 depicts a system 100 for providing such information content to be displayed during a computer-based application, according to an embodiment of the present invention. System 100 comprises a campaign management system (CMS) server 104, a content delivery network (CDN) server 106, and the computer-based application 108. Each server 104 and 106 comprises a central processing unit (CPU) 110 and 124, support circuits 112 and 126, and a memory 114 and 128, respectively. The support circuits 112 and 126 are well known and comprise power supplies, clocks, input/output interface circuitry, and the like.

Memory 114 and 128 comprise any random access memory, read only memory, removable disk memory, flash memory, and various combinations of these types of memory. The memory 114 and 128 is sometimes referred to as main memory and may in part be used as cache memory or buffer memory. The memory 114 and 128 stores various software packages and components, such as an operating system (O/S) 116 and 130, respectively.

To provide information content that will be displayed during a computer-based application, the information content 102 is loaded into the campaign management application 118, located in memory 114 of the CMS server 104. Such content comprises advertising information, such as, for example, ads to be run during play of an online game, promotional information, such as, for example, an entry form into a contest sponsored by a game advertiser, training information, such as, for example, employee development training offered through a desktop work application, news information, such as, for example, sportscasts provided during play of a online sports game, and the like.

The campaign management application 118 receives the information content 102 in the form of information content definitions and creatives files. The information content definitions include data for displaying the information during the application 108, such as how the content should be displayed, for example, as a single text image or as a texture display, the time length the content should be displayed, the order the content should be displayed in comparison to other content also to be displayed, and the like. The creatives files specify the display and pictorial elements of the information content, such as the text, graphical images, and the like. The campaign management application 118 receives the content 102 and develops content logic files including software code for displaying the information content. These content logic files are then transmitted to a pack manager application 122, located in the memory 114 of the CMS server 104. The pack manager application 122 receives the content logic files and creates application-specific information content packs comprising a plurality of content sets. Since the content packs may be displayed in a variety of computer-based applications, such as, for example a video game or an e-mail application, the content packs must be developed for the specific application.

Once created, the information content packs are delivered to an information pack application 132 located in the memory 126 of the CDN server 106 via the Internet 134. The information pack application 132 stores the content packs until one or more of the content packs are downloaded by a client software development kit (SDK) 136, which is located within the application 108. The client SDK 136 is a library of code that includes logic for providing methods to the application 108 to retrieve a specific content pack to be displayed at a given time and at a given location within the application 108. The client SDK 136 connects to the CDN server 106 through the Internet 134. In an alternate embodiment, the client SDK 136 is located outside the application 108, such as on a separate application server.

Either periodically or dynamically, the client SDK 136 downloads one or more content packs and stores the content packs until they are to be displayed in the application 108, to a user 140. The computer-based application may be a console game, an online video game, a mobile video game, a desktop application, or any Internet-enabled display application. The client SDK 136 communicates with the application 108 by means of software functions, wherein the client SDK 136 downloads a specific content pack into the application 108 associated with a specific function call produced by the application 108. Since the client SDK 136 resides within the application 108, the content packs are downloaded into the application 108 and displayed even in the application 108 is not connected to the CDN server 106 through the Internet 134. For example, if the user 140 downloads the application 108 onto his or her personal computer hard drive and uses the application 108 while not connected to the Internet 134, the application 108 continues to display the content packs previously downloaded and stored into the client SDK 136.

User reactions to the content displayed is measured by collecting impression metrics 138 from the users 140 through the application 108, where the metrics are temporarily stored in the client SDK 136. The impression metrics 138 are then transmitted to an impression metrics database 120, located in memory 114 of the CMS server 104. The metrics then are manipulated into a report to for delivery. So long as the application 108 is connected to the Internet 134, the impression metrics 138 may be delivered periodically or dynamically to the impression metrics database 120. If the connection between the application 108 and the Internet 134 is removed, the client SDK 136 will continue to obtain the user impression metrics 138 from the application 108 and will deliver the impression metrics 138 once the connection to the Internet 134 is restored.

Such a system 100 therefore overcomes the disadvantages of previous systems for providing information content and advertisements during computer-based applications by allowing for the content to be displayed regardless of a connection between the application and the Internet as well as continually collecting user impression metrics even though the user is using the application but not connected to the Internet.

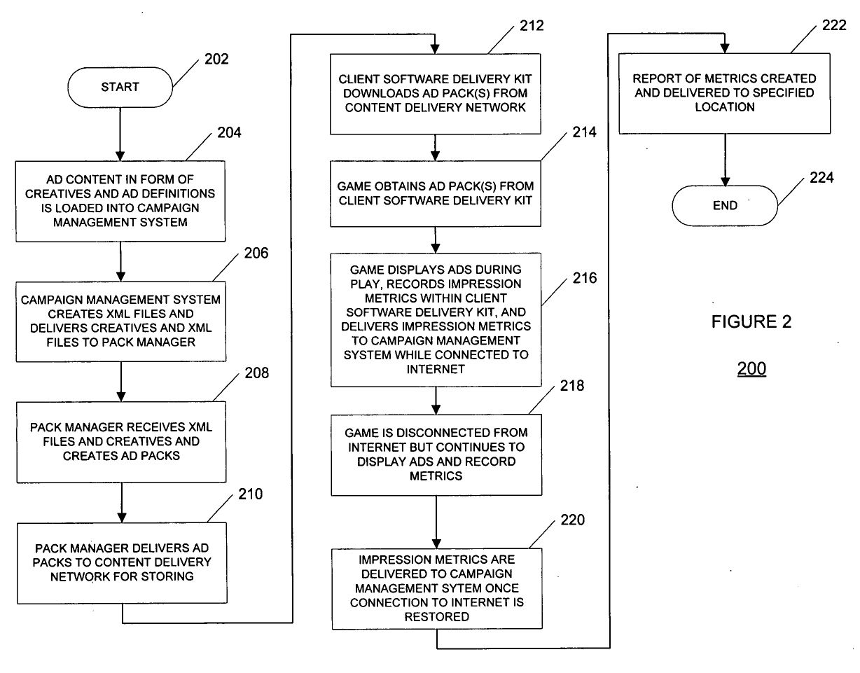

FIG. 2 describes a method 200 for providing in-game advertising and for collecting ad impression metrics to determine the effectiveness of such in-game advertising. The method 200 describes the functional steps taken by a system for providing such in-game advertising, such as the system 100 described in FIG. 1. The steps need not necessarily occur in the order described, and some steps may occur essentially simultaneously. Further, although the method 200 is described specific to displaying advertisements during an online video game, the scope of the invention reasonably encompasses display of an advertisement in any internet-enabled application, including, but not limited to, computer games, in-console games, such as PlayStationm (the trademark PLAYSTATION is registered to Kabushiki Kaisha Sony Computer Entertainment TA Sony Computer Entertainment Inc), mobile games, computerized display applications, and the like.

To start, a game publisher would have a desire to display one or more advertisements during game play to users. The publisher would supply information such as, but not limited to, the types of ads needed, the parameters associated with each ad, such as the content of each ad, display size, screen portion, time duration for each ad, and the like, and the number of ads to be displayed. The game publisher would supply the ad information in the form of creatives files and ad definitions. As previously discussed, the creatives files specify the display and pictorial elements of the advertisement, such as the text, graphical images, and the like of the advertisement, while the ad definitions provide parameters such as data for displaying the information during the application 108, such as how the content should be displayed, for example, as a single text image or as a texture display, the time length the content should be displayed, the order the content should be displayed in comparison to other content also to be displayed, and the like. Once such information is supplied, method 200 begins at step 202 and proceeds to step 204 where the ad content is loaded into a campaign management system, such as, for example, the campaign management application 118 in FIG. 1.

At step 206, the campaign management system creates content logic files comprising all of the variables and parameters previously supplied in step 204. In this embodiment, the content logic files are split into Extensible Markup Language (XML) files and the previously supplied creatives files. The XML files comprise the logic code for each advertisement, including when the ad should be displayed, how long the ad should be displayed, in which games and other computer-based applications the ad should be displayed, and the like. Both the XML files and the creatives files are transmitted to a pack manager application, such as the pack manager application 122 in FIG. 1.

The XML file includes a plurality of ads pertaining to a single game and platform combination and includes, but is not limited to, the following parameters arranged in a hierarchical structure:

1. Game
a. Game identification code.
b. Name of Game.
c. List of Locations within the Game.
   1. Location Name.
   2. Identification Code, representing a unique location in the game where the ad is displayed. For example, location id 1 could be the loading screen, while location id 2 could be a specific billboard in the game.
d. List of Campaigns.
   1. Campaign Name, representing the name of the campaign managing a specific ad.
   2. Identification Code.
e. List of Placements.
   1. Placement Name, representing the name of the placement inside the campaign managing a specific ad.
   2. Identification Code.
f. List of Ads.
   1. Advertisement Name.
   2. Identification Code.
g. Start Date—The date this ad will start showing.
h. End Date—The date this ad will stop showing.
i. Session Frequency—The limit of how often this ad will be displayed during this gaming session, where a session is defined as the time between the moment the game starts and the moment when the game is shutdown (or the console is shutdown).
j. Daily Frequency—The limit of how often this ad will be displayed in any given day.
k. Impression Goal—The maximum times this ad should be displayed at all.
l. Creative Path.
m. List of Custom Properties.
   1. Name.
   2. Value.

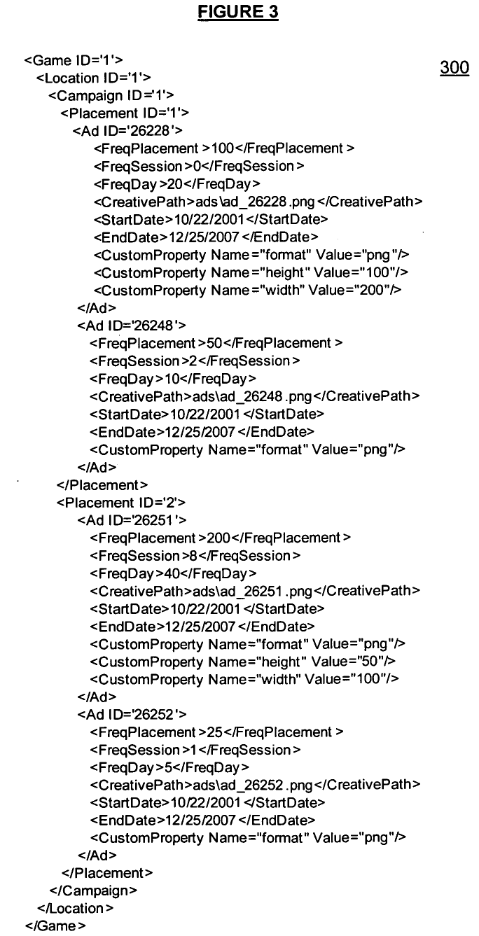

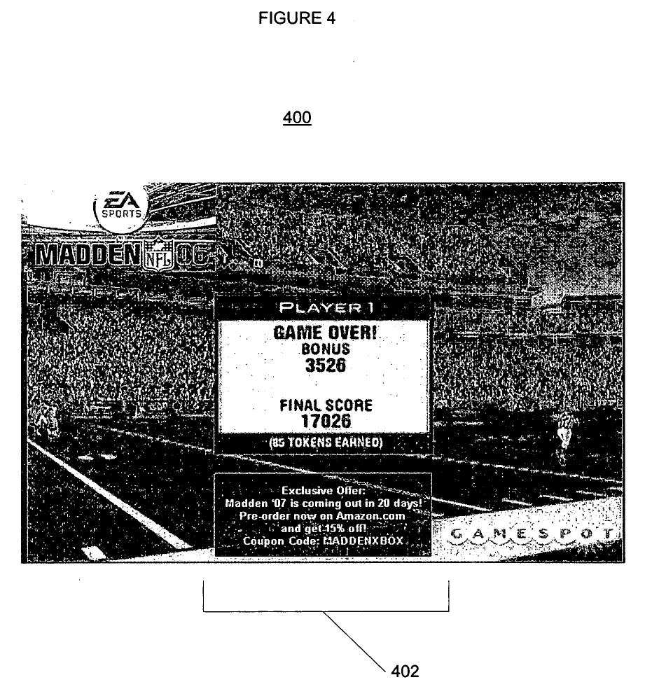

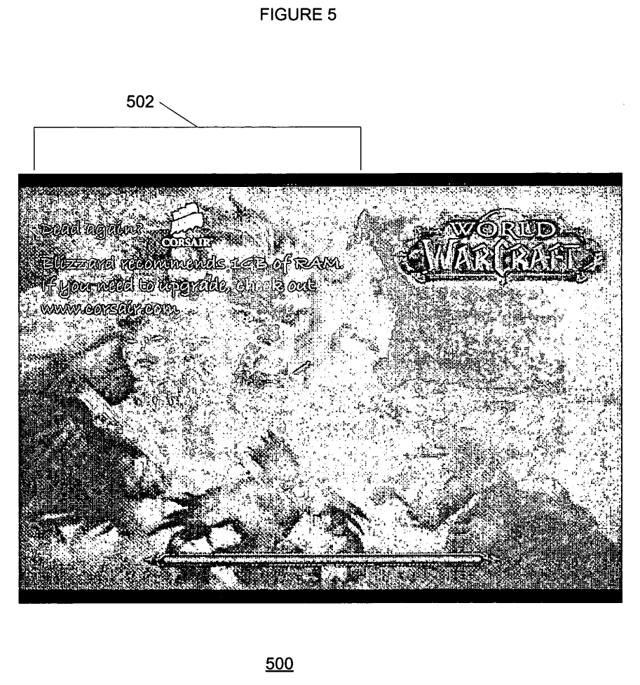

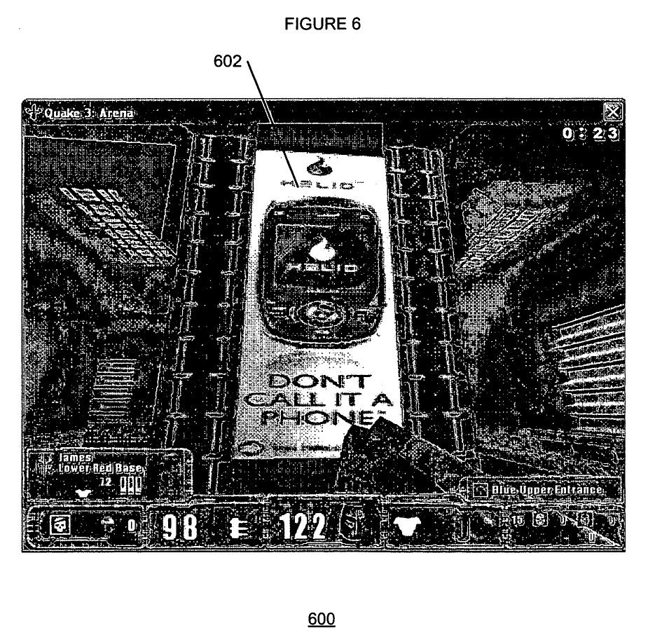

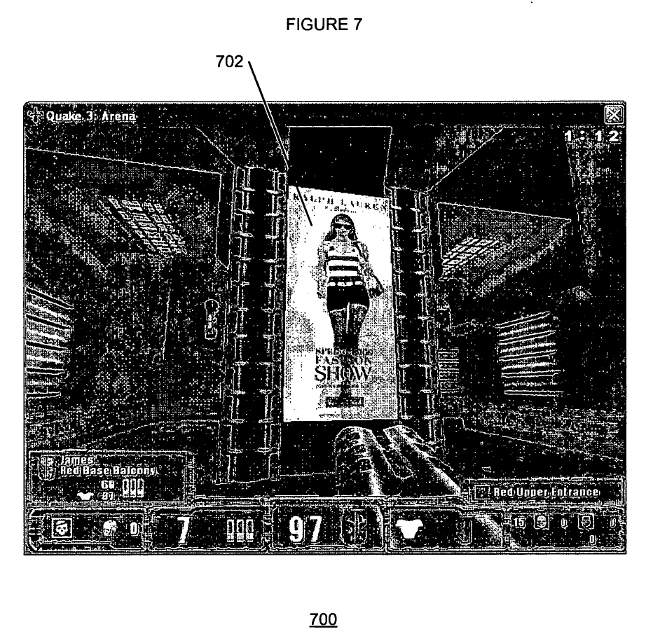

FIG. 3 illustrates implementation of the XML file parameters with parameter values, as shown by reference numeral 300, that is created by the campaign management system for placing a specific advertisement into a specific game as in step 206.

The pack manager application receives the XML and creatives files and begins to create the actual advertisements to be displayed, in step 208. The pack manager bundles the XML files and the creatives files into one or more ad packs that are formatted specifically to each game and/or computer-based application to which the ads are intended for display. The pack manager application bundles the files into ad packs that contain all of the information for a client software development kit, discussed in further detail below, to display the ads in the game and perform the rotation logic, while also providing the game with the ad creatives to display without requiring the game to be connected to the Internet or a game server.

The ad packs include, but are not limited to, a series of files compressed using a compression algorithm, such as, for example, the Lempel-Ziv-Markov Chain Algorithm (LZMA). Each ad pack includes parameters and variables similar to the XML file parameters received from the campaign management system in step 206, in FIG. 2. These parameters and variables include:
1. Ad Pack Info.
   a. Version.
   b. Game Id.
   c. Number of Ads.
2. List of all ads with each ads campaign definition.
   a. Ad ID—a unique identification code describing this ad that may be used to report usage metrics.
   b. Location ID.
   c. Campaign ID.
   d. Placement ID.
   e. Start Date.
   f. End Date.
   g. Session Frequency.
   h. Daily Frequency.
   i. Impression Goal.
   j. File Name—the name of the file contained in this Ad Pack that represents this ad. Depending on the ad format, this file may reference other files in this Ad Pack.
   k. Custom Property list with a name and a value for each property.

Once the ad packs have been generated, the pack manager delivers the ad packs to a content delivery network, in step 210. The pack manager delivers the ad packs to the content delivery network dynamically or periodically, in accordance with the ad definitions previously received with the ad content by the campaign management system in step 204 of FIG. 2. The content delivery network comprises one or more servers enabled to deliver the game to multiple users in multiple locations, such as the CDN server 106 described in FIG. 1.

The content delivery network stores the ad packs until one or more of the ad packs are downloaded by the client software development kit at step 212, similar to the client SDK 142 described in FIG. 1. The client software development kit is located within the gaming application and communicates with the content delivery network through the Internet. The client software development kit includes a code library used by the game during game execution to download one or more ad packs received from the content delivery network by providing downloading methods to the game to retrieve an ad for display, as in step 214. Because the client development software kit is located within the game application, the game does not need to be connected to the Internet to display and rotate through advertisements from an ad pack once the ad pack is downloaded by the client software development kit.

The downloading methods available to the game for ad retrieval include calling a software function that returns an identification code of an ad where the specified identification code corresponds to a location in the game where the ad is to be displayed. For example, if a game wishes to display an ad for a specific location numbered location 2, the game calls a function to the client software development kit coded as “VIG_GetAdForPlacement.” This function receives the location, location 2, as input and returns an identification code representing the ad that should be displayed. The game then sends a second function “VIG_GetAdData” to the client software development kit that receives the ad identification code as input from the client software development kit, and returns a pointer to the ad content. The game then presents the specified ad to one or more users.

The client software development kit also contains a set of rules for displaying an ad from the ad pack, as determined by the game publisher. This set of rules include, but is not limited to, the following elements:
1. Add all ads for this placement in a list, and for each ad perform steps a-e.
   a. If it's before the start date remove this ad from the list.
   b. If it's after the end date remove this ad from the list.
   c. If the ad been shown more then the current value assigned to Session Frequency times since the user started playing this game remove this ad from the list.
   d. If the ad has been shown more then the current value assigned to Daily Frequency times since 12 AM today remove this ad from the list.
   e. If the ad has been shown more then the current value assigned to Impression Goal times total remove this ad from the list.
2. If more only one ad remains in the list, show it.
3. If more then one ad remains in the list, assign appropriate weights for each ad. The appropriate weights will be calculated based on:
   a. The ad location id compared to the desires location id.
   b. The start date compared to the current date.
   c. The end date compared to the current date.
   d. The status if the ad was cached already.
4. Sort the list by weight in ascending order.
5. Randomly select an ad for the current location id with the highest weights.
6. Display the “selected ad.”
   If, at the end of this process, no ads have been selected to be displayed, the client software development kit returns no ad to be displayed, and the game displays game content in place of the ad.

Another function call also is generated between the game and the client software development kit when an ad pack update is received by the client software development kit. For example, when the client software development kit downloads and parses an update to a previously loaded ad pack file, the client software development kit removes any ads that are no longer referenced by the new ad pack, and uploads any new ads to the previously loaded ad pack file.

An embodiment of the present invention provides a method comprising the step of securing the downloaded ad packs to prevent unwanted modification or manipulation. For example, an ad pack signature is created using a digital signature algorithm (DSA). The digital signature is created with a SHA-1 (Secure Hash Algorithm) hash value associated with the ad pack. The hash value then is encrypted using an encryption algorithm for security protection. The encrypted hash value becomes the unique digital signature for the ad pack, which is appended to the ad pack file.

Prior to loading an ad pack into the game system, the client software development kit verifies the digital signature of the ad pack. An ad pack with an invalid signature will not be loaded into the game, and will be removed from the client software development kit. The digital signature creation and verification process is done automatically and is transparent to the user.

At step 216 in FIG. 2, the game displays the ads within the ad pack during execution of the game and while connected to the Internet. Additionally, ad impression and user interaction metrics for each advertisement are collected by the game application and are recorded in the client software development kit. At a specified time, the recorded impression metrics are delivered from the client software development kit to the campaign management system for further reporting (discussed below), via the Internet. Such metrics include, but are not limited to, a unique Ad ID associated with a specific ad, an impression count, an impression count since the last function call for the ad was sent, a click through impression count since the last function call for the ad was sent, display duration time for the ad, overall display duration time since the last function call for the ad was sent, number of times the ad was displayed for different game starts, number of times the ad was displayed at the current day, a timestamp of the last time any data for the Ad ID was sent, and the like.

Periodically or dynamically, the client software development kit transmits a functional call to the game for any accumulated impression metrics data for a specific ad to be sent. This functional call includes certain parameters such as, but not limited to, identification of the call type, for example, an update confirmation function or a metrics reporting function, a unique Ad ID, the timestamp of the last time a call for the Ad ID was sent, an impression count since the last call for the ad was sent, display duration time of the ad since the last call for the ad was sent, a click-through impression count since the last call for the ad was sent, and a last console call time, which is the last point in time that the given game console reported a call made by the impression metrics application. The console call time is recorded only for the first call made on a given day, while all subsequent calls made on that same day will not have this parameter.

Additional impression metrics include, but are not limited to, a click-thru-rate or the total number of click-through divided by the total number of impressions, the number of positive user advertisement interactive events received, that is, how many ads did a user click on to obtain further information, the interaction rate or the number of positive user-initiated interactions divided by the total number of impressions, the number of calls received by the impression metrics application, an average display time defined as the total display time of an advertisement divided by the total time impressions, total game-play time, and an average game-play time defined as the total game-play time divided by the total time impressions.

As an example, the client software development kit provides a function call to be notified by the game about the display of a certain advertisement in a single display frame. Based on multiple calls for a certain ad in each display frame, the client software development kit determines the duration of the ad display time. The impression metrics for an advertisement are recorded based on certain criteria, such as the Ad ID number, the display duration, a relative display size of the ad compares to the full screen of the game, and a display angle in which the ad can be seen. Further, the impression metrics are recorded only if the ad data meet specific criteria originally provided in the ad content loaded into the campaign management system in step 204 of FIG. 2. For example, such criteria includes that an ad have a minimum duration time of 2 seconds, a minimum relative display size of 20%, and a display angle smaller than a maximum allowed display angle of 50°. Advertisements that do not meet the criteria will not be recorded for impression metrics. Additionally, impression metrics criteria may be customized for each ad within an ad pack.

If the game application is disconnected from the Internet, the game still continues to display ads and to collect ad impression metrics because the client software development kit is located within the game application, as shown in step 218, but does not deliver the impression metrics to the campaign management system. This feature allows the game to show and rotate through the ads from downloaded ad packs even if the game is being played offline. Additionally, the ad impressions metrics for each ad are collected and stored in the client software development kit even if the game is being played offline. When the connection does not exist between the game and the Internet, the impression metrics data are temporarily saved on the game console hard drive, such as a user's personal computer. Once the game reconnects to the Internet, all saved accumulated impression metrics data is sent to campaign management system, as shown in step 220 of FIG. 2. Thus, a game publisher does not lose any impression data simply because a user is playing the game offline, nor does the game publisher lose advertisement time due to the game being played offline.

The collected impression metrics delivered to the campaign management system, in steps 216 and 220, are stored in a database, such as the impression metrics database 120 described in FIG. 1. Upon request, the ad impression metrics are manipulated and combined to produce a customized report determining the efficacy of each advertisement, the effectiveness of providing advertisements during a specific game or other computer-based application, and the like. The report then is delivered to the game publisher, a third party, or any specified destination, as shown in step 222. The process then ends at step 224, although any of the above steps may be repeated, either periodically or continuously.

In yet another embodiment of the present invention, a method for providing in-game advertising includes the step of providing promotional content to be displayed such as a promotional contest. For example, a golf game displays advertising stating that on Dec. 1, 2007 the first 10 users to hit a hole in one on the fourth golfing hole of a particular course will each win a new car. Such promotional advertising may generate interest for users to purchase the game and begin playing the game in order to be skilled enough to play on December 1 to win a prize. Once a user wins the promotion, the user's personal information is collected through the game and delivered to the game publisher.

Although some embodiments of the invention are presently described in connection to providing advertisements during a computer video game, one of ordinary skill in the art would reasonably recognize that the scope of the invention is not limited to such embodiments, but encompasses embodiments comprising a system and method for providing promotional and information content during any computer-based application, including, but not limited to, in-console games, mobile games and other internet-enabled platforms, such as, for example, computerized billboards and displays, home appliances, geographic positional systems, mobile telephones. These and other embodiments of the present invention may be devised without departing from the basic scope thereof, where the scope thereof is determined by the following claims.

We claim:

1. A method for providing information content displayed during a computer-based application, comprising the steps of:
creating an information content pack, wherein the pack comprises a plurality of content sets;
delivering the information content pack to at least one server;
downloading the information content pack from the at least one server;
displaying at least one content set from the plurality of content sets while the computer-based application is engaged by a user even if a connection does not then exist between the computer-based application and an associated application server;
collecting a set of impression metrics while the computer-based application is engaged by the user even if a connection does not then exist between the computer-based application and the associated application server; and
delivering the set of impression metrics to the at least one server when the computer-based application is engaged by the user and is connected to the associated application server.

2. The method recited in claim 1 wherein the computer-based application is one of a computer game, a desktop application, or a display application.

3. The method recited in claim 1 wherein the step of delivering the information content pack occurs periodically.

4. The method recited in claim 1 wherein the step of delivering the information content pack occurs dynamically.

5. The method recited in claim 1 wherein the step of downloading the information content pack occurs periodically.

6. The method recited in claim 1 wherein the step of downloading the information content pack occurs dynamically.

7. The method recited in claim 1 wherein the plurality of content sets comprises at least one of advertisements, promotional information, training information, and news information.

8. The method recited in claim 1 wherein the step of displaying the at least one content set further comprises displaying the at least one content set as a single image comprising at least a portion of a computer-based application viewing screen within the computer-based application.

9. The method recited in claim 1 wherein the step of displaying the at least one content set further comprises the step of displaying the at least one content set as a texture display within a viewing screen of the computer-based application.

10. The method recited in claim 1 further comprising the step of rotating through additional content sets from the plurality of content sets while the computer-based application is engaged by the user even if a connection does not then exist between the computer-based application and the at least one server.

11. The method recited in claim 1 further comprising the step of adding a unique security identifier to information content pack to prevent unwanted modification.

12. The method recited in claim 11, wherein the unique security identifier comprises a digital signature.

13. The method recited in claim 11 wherein the step of retrieving the information content pack from the at least one server further comprises the step of verifying the unique security identifier.

14. The method recited in claim 13 further comprising the step of discarding the information content pack if the verification step fails.

15. The method recited in claim 1 further comprising the step of delivering the set of impression metrics to a third party.

16. A computer system for providing information content displayed during a computer-based application, comprising:
a central processing unit;
a set of support circuits; and
a first server, wherein the first server stores and maintains a memory comprising:
at least one operating system;
a campaign management application for receiving the information content and generating a plurality of content logic files;
a pack manager application for obtaining the plurality of content logic files from the campaign management application and creating at least one information content pack to be displayed during engagement of the computer-based application; and
an impression metrics database for storage of user impression metrics;
a second server, wherein the second server stores and maintains a memory comprising:
at least one operating system; and
an information content pack application for obtaining the at least one information content pack from the first server and storing the at least one information content pack; and
a client software development kit for downloading the at least one information content pack from the second server at a specific point in time and delivering it to the computer-based application for display, and for collecting the user impression metrics.

17. The system recited in claim 16 wherein the plurality of content logic files comprises XML files and creatives files.

18. The system recited in claim 16 wherein the at least one information content pack comprises at least one of text, sound files, graphical images, video images, three-dimensional objects, animations, textures, two-dimensional sprites, game objects, game levels, and game loading screens.

19. The system recited in claim 16 wherein the second server is a content delivery network server.

20. The system recited in claim 16 wherein the computer-based application is one of a console game, an online video game, a mobile video game, a desktop application, or an Internet-enabled display application.

21. The system recited in claim 16 wherein the client software development kit is located within the computer-based application.

22. The system recited in claim 16 wherein the client software development kit is located outside the computer-based application.

23. A system for providing in-game advertising and reporting of ad impression metrics, comprising:
a first software function, which, in response to content files, creates an advertisement pack and downloads the pack to a server;
a second software function, responsive to a function call executed within a computer game, for accessing and downloading the advertisement pack from the server and displaying a corresponding advertisement at a predetermined location during the game as defined by the function call;
wherein the advertisement pack permits the software function to display advertisements and dynamically rotate advertisements for display even if a connection does not then exist between the game and the server;
a third software function for collecting a set of ad impression metrics associated with each corresponding advertisement displayed during the game even if a connection does not then exist between the game and the server; and
a fourth software function that reports the set of ad impression metrics when the game is connected to the server.

24. A computer-readable medium storing a computer program for providing information content displayed during a computer-based application, comprising a plurality of modules, wherein the plurality of modules perform the following functions:
creating an information content pack, wherein the pack comprises a plurality of content sets;
delivering the information content pack to at least one server;
downloading the information content pack from the at least one server;
displaying at least one content set from the plurality of content sets while the computer-based application is engaged by a user even if a connection does not then exist between the computer-based application and an associated application server;
collecting a set of impression metrics while the computer-based application is engaged by the user even if a connection does not then exist between the computer-based application and the associated application server; and
delivering the set of impression metrics to the at least one server when the computer-based application is engaged by the user and connected to the associated application server.
